(19) United States
(12) Patent Application Publication
(10) Pub. No.: US 2014/0031487 A1
(43) Pub. Date: Jan. 30, 2014

(54) EPOXIDISED ELASTOMER COMPOSITIONS MODIFIED BY SILANES

(71) Applicants: Laurent Guy, Rillieux La Pape (FR); Thomas Chaussee, Thivencelle (FR)

(72) Inventors: Laurent Guy, Rillieux La Pape (FR); Thomas Chaussee, Thivencelle (FR)

(73) Assignees: RHODIA OPERATION, Aubervilliers (FR); DOW CORNING CORPORATION, Midland, MI (US)

(21) Appl. No.: 13/883,101

(22) PCT Filed: Nov. 3, 2011
(86) PCT No.: PCT/EP2011/069291

§ 371 Date: Sep. 30, 2013

(30) Foreign Application Priority Data
Nov. 3, 2010 (EP) 10306203.0

(51) Int. Cl. C08F 279/02

(52) U.S. Cl. CPC C08F 279/02
USPC 524/572; 525/288

(57) ABSTRACT

This invention relates to the modification of elastomers especially epoxidised rubber by reaction with unsaturated silanes, to the modified elastomers produced and to articles produced by shaping and curing modified elastomer compositions. In a process according to the present invention, the silane has the formula:

R″—CH═CH—C(O)X—Y—SiRₐR′₍₃₋ₐ₎ (I) or

R″—C≡C—C(O)X—Y—SiRₐR′₍₃₋ₐ₎ (II)

in which R, R′, a, Y, X and R″ are as defined in the description.

This invention relates to the modification of elastomer compositions especially epoxidised rubber by reaction with unsaturated silanes, to the modified elastomers produced and to articles produced by shaping and curing modified elastomer compositions. It also relates to the use of unsaturated silanes as coupling agents in filled elastomer compositions.

WO-01/49781-A and US 2004/0249048-A1 describe a sulphur-vulcanisable rubber composition useful for the manufacture of tyres comprising a diene elastomer, a reinforcing white filler, a coupling agent and a heat-triggered radical initiator. The coupling agent is an alkoxysilane having at least one activated double bond, in particular trimethoxysilylpropyl methacrylate.

WO 01/49782-A and US 2003/0065104 describe a rubber composition comprising a diene elastomer, a reinforcing agent and a coupling agent. The coupling agent comprises an ester function of an \acute{α}, β-unsaturated carboxylic acid bearing a carbonyl group on its γ-position. In particular acrylamido-functional silanes were described, e.g. fumaramic and maleamic esters.

WO 01/49783-A and US 2003/0144403 describe the use of a functionalized organosilane comprising an activated ethylenic double bond, together with a radical initiator, as a coupling system in compositions comprising a diene elastomer and a white reinforcing filler. In particular acrylamido-functional silanes were described, e.g. fumaramic and maleamic esters.

EP 1134251 describes a primer composition containing 2 polymers each having at least one silicon-containing group having a hydroxyl group or a hydrolysable group bonded to a silicon atom and capable of cross-linking by forming a siloxane bond. The polymerisation is effected in presence of a solvent and a radical initiator.

GB1407827-A describes the polymerisation in aqueous phase and in the presence of a water-soluble free-radical initiator of a mixture of styrene and up to 40% by weight (relative to the mixture) of butadiene with a specific silicon-containing compound having an unsaturated organic radical.

JP2008106118 A and EP2085419 A1 describe a process including subjecting an alkali metal active end of a conjugated diene polymer to a modification reaction with an alkoxysilane compound.

JP 2008/184545-A describes a rubber composition including a filler containing silicic acid, a silane coupling agent and a bismaleimide compound.

WO 02/22728-A and U.S. Pat. No. 7,238,740-B describe an elastomeric composition based on an isoprene elastomer, a reinforcing inorganic filler and, as coupling agent, a citracominido-alkoxysilane.

JP632701751 describes the use of thiomethacrylic silanes of the general formula CH₂═C(CH₃)C(═O)S(CH₂)₁₋₆Si(OCH₃)₃ in tire tread compositions of synthetic rubbers.

The process described in WO-01/49781-A requires the presence of a radical initiator. The specific silanes described in JP 2008/184545-A and WO 02/22728-are not commercially available presumably because of cost and/or stability issues.

It is desirable to provide a process for modifying epoxidised Rubber using an activated silane of reasonable cost and with appropriate thermal stability, without any free radical initiator.

In a process according to the present invention for modifying an epoxidised rubber by reaction with an olefinically unsaturated silane having at least one hydrolysable group bonded to silicon, the silane has the formula:

R″—CH═CH—C(O)X—Y—SiRₐR′₍₃₋ₐ₎ (I) or

R″—C≡C—C(O)X—Y—SiRₐR′₍₃₋ₐ₎ (II)

in which R represents a hydrolysable group; R′ represents a hydrocarbyl group having 1 to 6 carbon atoms; a has a value in the range 1 to 3 inclusive; Y represents a divalent organic spacer linkage comprising at least one carbon atom separating the linkage —C(O)X— from the Si atom, X is S or O; and R″ represents hydrogen or a group having an electron withdrawing effect with respect to the —CH═CH— or —C≡C— bond; and the silane is reacted with the epoxidised rubber in the absence of any free radical initiator.

An electron-withdrawing moiety is a chemical group which draws electrons away from a reaction centre. The electron-withdrawing moiety R″ can in general be any of the groups listed for dienophiles in Michael B. Smith and Jerry March; March's Advanced Organic Chemistry, 5^{th} edition, John Wiley & Sons, New York 2001, at Chapter 15-58 (page 1062). The moiety R″ can be especially a C(═O)R*, C(═O)OR*, OC(═O)R*, C(═O)Ar moiety in which Ar represents aryl and R* represents a hydrocarbon moiety. R″ can also be a C(═O)—NH—R* moiety. R″ cannot be an electron-donating group, for example alcohol group, amino group, or terminal alkyl group such as methyl which furthermore produces steric hindrance to the —CH═CH— or —C≡C— bond.

Optionally Y may additionally include one or more heteroatoms such as, for example, sulphur (S), oxygen (O) or nitrogen (N). In one embodiment X is preferably O.

Epoxidised rubber, for example Epoxidised Natural Rubber (ENR), is obtained by modifying rubber, for example natural rubber, in which some insaturation are replaced by epoxy groups through a chemical modification. Useful epoxidized rubber will have an extent of epoxidation of about 5 to about 95 mole %, preferably from about 15 to about 80 mole %, and more preferably from about 20 to about 50 mole %, where the extent of epoxidation is defined as the mole percentage of olefinically unsaturated sites originally present in the rubber that have been converted to oxirane, hydroxyl, or ester groups.

Epoxidation reactions can be effected by reacting an unsaturated rubber with an epoxidizing agent. Useful epoxidizing agents include peracids such as m-chloroperbenzoic acid and peracetic acid. Other examples include carboxylic acids, such as acetic and formic acid, or carboxylic anhydrides such as acetic anhydride, together with hydrogen peroxide. A catalyst, such as sulfuric acid, p-tolulene sulfonic acid, or a cationic exchange resin such as sulfonated polystyrene may optionally be employed.

Epoxidation is preferably conducted at a temperature from about 0° to about 150° C. and preferably from about 25° to about 80° C. The time required to effect the epoxidation reaction is typically from about 0.25 to about 10 hours, and preferably from about 0.5 to about 3 hours.

The epoxidation reaction is preferably conducted in a solvent that is capable of substantially dissolving the rubber both in its original condition and after epoxidation. Suitable solvents include aromatic solvents such as benzene, toluene, xylene, and chlorobenzene, as well as cycloaliphatic solvents such as cyclohexane, cycloheptane, and mixtures thereof.

After epoxidation, the epoxidized rubber is preferably removed or isolated from the acidic environment, which may include the epoxidizing agents as well as the acidic catalyst. This isolation can be accomplished via filtration, or by adding a dilute aqueous base to neutralize the acid and then subsequently coagulate the polymer. The polymer can be coagulated by using an alcohol such as methanol, ethanol, or propanol. An antioxidant is typically added after the isolation procedure, and the final product may be dried using techniques such as vacuum distillation. Alternatively, other known methods for removing polymers from hydrocarbon solvents and the like may be employed including steam stripping and drum drying.

Other diene elastomers can also be used in epoxidised form such as, but not limited to, those rubbers that derive from the polymerization of conjugated dienes alone or in combination with vinyl aromatic monomers.

The diene elastomer can be natural rubber. We have found that the unsaturated silanes of the invention graft readily to natural rubber and also acts as an effective coupling agent in a curable filled natural rubber composition.

The diene elastomer can alternatively be a synthetic polymer which is a homopolymer or copolymer of a diene monomer (a monomer bearing two double carbon-carbon bonds, whether conjugated or not). Preferably the elastomer is an “essentially unsaturated” diene elastomer, that is a diene elastomer resulting at least in part from conjugated diene monomers, having a content of members or units of diene origin (conjugated dienes) which is greater than 15 mol %. More preferably it is a “highly unsaturated” diene elastomer having a content of units of diene origin (conjugated dienes) which is greater than 50 mol %. Diene elastomers such as butyl rubbers, copolymers of dienes and elastomers of alpha-olefins of the ethylene-propylene diene monomer (EPDM) type, which may be described as “essentially saturated” diene elastomers having a low (less than 15 mol %) content of units of diene origin, can alternatively be used but are less preferred.

The diene elastomer can for example be:
(a) any homopolymer obtained by polymerization of a conjugated diene monomer having 4 to 12 carbon atoms;
(b) any copolymer obtained by copolymerization of one or more dienes conjugated together or with one or more vinyl aromatic compounds having 8 to 20 carbon atoms;
(c) a ternary copolymer obtained by copolymerization of ethylene, of an [alpha]-olefin having 3 to 6 carbon atoms with a non-conjugated diene monomer having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene;
(d) a copolymer of isobutene and isoprene (butyl rubber), and also the halogenated, in particular chlorinated or brominated, versions of this type of copolymer.

Suitable conjugated dienes are, in particular, 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds are, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl aromatic units. The elastomers may have any microstructure, which is a function of the polymerization conditions used, in particular of the presence or absence of a modifying and/or randomizing agent and the quantities of modifying and/or randomizing agent used. The elastomers may for example be block, statistical, sequential or microsequential elastomers, and may be prepared in dispersion or in solution; they may be coupled and/or starred or alternatively functionalized with a coupling and/or starring or functionalizing agent. Examples of preferred block copolymers are styrene-butadiene-styrene (SBS) block copolymers and styrene-ethylene/butadiene-styrene (SEBS) block copolymers.

Preferred are polybutadienes, and in particular those having a content of 1,2-units between 4% and 80%, or those having a content of cis-1,4 of more than 80%, polyisoprenes, butadiene-styrene copolymers, and in particular those having a styrene content of between 5% and 50% by weight and, more particularly, between 20% and 40% by weight, a content of 1,2-bonds of the butadiene fraction of between 4% and 65%, and a content of trans-1,4 bonds of between 20% and 80%, butadiene-isoprene copolymers and in particular those having an isoprene content of between 5% and 90% by weight. In the case of butadiene-styrene-isoprene copolymers, those which are suitable are in particular those having a styrene content of between 5% and 50% by weight and, more particularly, between 10% and 40% by weight, an isoprene content of between 15% and 60% by weight, and more particularly between 20% and 50% by weight, a butadiene content of between 5% and 50% by weight, and more particularly between 20% and 40% by weight, a content of 1,2-units of the butadiene fraction of between 4% and 85%, a content of trans-1,4 units of the butadiene fraction of between 6% and 80%, a content of 1,2- plus 3,4-units of the isoprene fraction of between 5% and 70%, and a content of trans-1,4 units of the isoprene fraction of between 10% and 50%.

The elastomer can be an alkoxysilane-terminated diene polymer or a copolymer of the diene and an alkoxy-containing molecule prepared via a tin coupled solution polymerization.

A modified epoxidised rubber according to the invention is grafted with groups of the formula:

R″−CH(P)—CH₂—C(O)X—Y—SiRₐR′₍₃₋ₐ₎ and/or the formula

R″—CH₂—CH(P)—C(O)X—Y—SiRₐR′₍₃₋ₐ₎ and/or the formula

R″—C(P)═CH—C(O)X—Y—SiRₐR′₍₃₋ₐ₎ and/or the formula

R″—CH═C(P)—C(O)X—Y—SiRₐR′₍₃₋ₐ₎,

where P represents an epoxidised rubber polymer residue; and Y, X, R, R′, R″ and a are defined as above.

Co-polymer of isobutylene and isoprene (known as butyl rubber) can be modified according to this invention using silane

R″—CH═CH—C(O)X—Y—SiRₐR′₍₃₋ₐ₎ (I) or

R″—C≡C—C(O)X—Y—SiRₐR′₍₃₋ₐ₎ (II)

wherein R, R′, a, Y, X and R″ are defined as above, advantageously R″ is as defined in WO2010/000477, WO2010/000478, WO2010/000479 (i.e. hydrogen or a group having an electron withdrawing effect or any other activation effect with respect to the —CH═CH— or —C≡C— bond), preferably R″ is a second insaturation leading to a conjugated system enabling more homogeneous grafting on butyl rubber.

In the unsaturated silane of the formula R″—CH═CH—X—Y—SiRₐR′₍₃₋ₐ₎ (VI) or R″—C≡C—X—Y—SiRₐR′₍₃₋ₐ₎ (VII), X is an electron withdrawing linkage, preferably a carboxyl linkage. Preferred silanes thus have the formula R″—CH═CH—C(═O)O—Y—SiRₐR′₍₃₋ₐ₎ (VIII). When the group R″ represents phenyl, the moiety R″—CH═CH—C(═O)O—Y— in the unsaturated silane (VIII) is a cinnamyloxyalkyl group. The unsaturated silane can for example be 3-cinnamyloxypropyltrimethoxysilane,

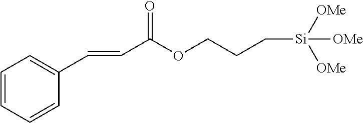 [SMILES: CO[Si](CCCOC(=O)/C=C/c1ccccc1)(OC)OC]

whose preparation is described in U.S. Pat. No. 3,179,612. Preferably the group R″ can be a furyl group, for example a 2-furyl group, with the silane being an alkoxysilylalkyl ester of 3-(2-furyl)acrylic acid, i.e.,

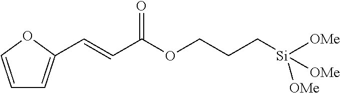 [SMILES: CO[Si](CCCOC(=O)/C=C/c1ccco1)(OC)OC]

Alternative preferred unsaturated silanes have the formula R2—CH═CH—CH═CH-A′-SiRₐR′₍₃₋ₐ₎, where R2 represents hydrogen or a hydrocarbyl group having 1 to 12 carbon atoms and A′ represents an organic linkage having an electron withdrawing effect with respect to the adjacent —CH═CH— bond. The linkage A′ can for example be a carbonyloxyalkyl linkage. The unsaturated silane can be a sorbyloxyalkylsilane such as 3-sorbyloxypropyltrimethoxysilane CH₃—CH═CH—CH═CH—C(═O)O—(CH₂)₃—Si(OCH₃)₃, i.e.,

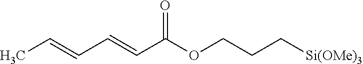

Other preferred unsaturated silanes have the formula A″-CH═CH—CH═CH-A-SiRₐR′₍₃₋ₐ₎, where A″ represents an organic moiety having an electron withdrawing effect with respect to the adjacent —CH═CH— bond and A represents a direct bond or a divalent organic linkage having 1 to 12 carbon atoms.

Co-polymer of isobutylene and isoprene (known as butyl rubber) can be modified according to this invention using silane

R″—CH═CH—C(O)X—Y—SiRₐR′₍₃₋ₐ₎ (I) or

R″—C≡C—C(O)X—Y—SiRₐR′₍₃₋ₐ₎ (II)

wherein R, R′, a, Y, X and R″ are defined as above, advantageously those silane are used with a co-agent enabling more homogeneous grafting on butyl rubber.

The co-agent which inhibits polymer degradation can alternatively be a compound containing an olefinic —C═C— or acetylenic —C≡C— conjugated with an olefinic —C═C— or acetylenic —C≡C— unsaturated bond. For example a sorbate ester, or a 2,4-pentadienoate, or a cyclic derivative thereof. Preferred co-agents are ethyl sorbate of the formula:

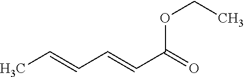

or octyl sorbate to allow a higher boiling point

The co-agent which inhibits polymer degradation can alternatively be a multi-functional acrylate, such as e.g., trimethylolpropane triacrylate, pentaerythritol tetracrylate, pentaerythriol triacrylate, diethyleneglycol diacrylate, dipropylenglycol diacrylate or ethylene glycol dimethacrylate, or lauryl and stearylacrylates.

The co-agent which inhibits polymer degradation is preferably added with the unsaturated silane and the compound such as a peroxide capable of generating free radical sites in the polyolefin. The co-agent, for example a vinyl aromatic compound such as styrene, is preferably present at 0.1 to 15.0% by weight of the total composition.

Co-polymer of isobutylene and isoprene (known as butyl rubber) can be modified according to this invention using silane

R″—CH═CH—C(O)X—Y—SiRₐR′₍₃₋ₐ₎ (I) or

R″—C≡C—C(O)X—Y—SiRₐR′₍₃₋ₐ₎ (II)

wherein R, R′, a, Y, X and R″ are defined as above, advantageously those silane are used with a with a second silane as defined in having same structure and R″ being a second insaturated hydrocarbon group as for example described earlier.

The invention also includes the use of a silane as a coupling agent for a butyl rubber composition containing a reinforcing filler.

The invention also includes the use of a silane having the formula:

R″—CH═CH—C(O)X—Y—SiRₐR′₍₃₋ₐ₎ (I) or

R″—C≡C—C(O)X—Y—SiRₐR′₍₃₋ₐ₎ (II)

wherein R, R′, a, Y, X and R″ are defined as above, as a coupling agent for an epoxidised rubber composition containing a reinforcing filler.

Epoxidised rubber compositions which are to be cured to a shaped rubber article generally contain a filler, particularly a reinforcing filler such as silica or carbon black. The rubber compositions are produced in suitable mixers, and are usually produced using two successive preparation phases: a first phase of thermo-mechanical mixing or kneading (sometimes referred to as “non-productive” phase) at high temperature, up to a maximum temperature (Tₘₐₓ) between 110°-190° C., followed by a second phase of mechanical mixing (sometimes referred to as “productive” phase) at temperature typically less than 110° C., during which vulcanization agents are incorporated. During the thermo-mechanical kneading phase, the filler and the rubber are mixed together in one or more steps.

In some applications such as energy-saving ‘green’ tyres, particularly isoprene polymer tyres for heavy vehicles, it is helpful to replace the carbon black filler using a combination of silica and a coupling agent, as disclosed in WO2006125534A1, WO2006125533A1 and WO2006125532A1. When producing rubber compositions, it is desirable that the compositions should be easily processable and require a low mixing energy, while producing cured rubber products having good physical properties such as hardness, tensile modulus and viscoelastic properties. Mixing a filler such as silica containing hydroxyl groups into an organic elastomer composition can be difficult. Various coupling agents have been used to improve the dispersion of the hydroxyl-containing filler in the rubber composition.

When the unsaturated silane according to the invention is present in the thermo-mechanical kneading phase, it can react with the epoxidised rubber to form a modified epoxidised rubber and can also act as a coupling agent bonding the filler to the epoxidised rubber. The unsaturated silanes according to the present invention react with the epoxidised rubber to form a grafted epoxidised rubber in the absence of any free radical initiator, which is advantageous because free radical initiators such as peroxides tend to degrade epoxidised rubber. In addition, safe handling and mixing of peroxides can be difficult for rubber compounders. The grafted epoxidised rubber produced has improved adhesion to substrates, for example reinforcing cords and fabrics used as reinforcement in rubber articles such as tyres.

Each hydrolysable group R in the —SiRₐR′₍₃₋ₐ₎ group of the unsaturated silane of the formula:

R″—CH═CH—C(O)X—Y—SiRₐR′₍₃₋ₐ₎ (I) or

R″—C≡C—C(O)X—Y—SiRₐR′₍₃₋ₐ₎ (II)

may be the same or different and is preferably an alkoxy group, although alternative hydrolysable groups such as acyloxy, for example acetoxy, ketoxime, amino, amido, aminoxy or alkenyloxy groups can be used. When R contains an alkoxy group, each R also generally contains a linear or branched alkyl chain of 1 to 6 carbon atoms or an ethylene glycol polymer chain. However most preferably each R is either a methoxy or ethoxy group. The value of a in the silane (I) or (II) can for example be 3, for example the silane can be a trimethoxysilane or triethoxysilane, to give the maximum number of cross-linking sites, when curing is done using reactive site from alkoxysilane. However each alkoxy group generates a volatile organic alcohol when it is hydrolysed, and it may be preferred that the value of a in the silane (I) or (II) is 2 or even 1 to minimize the volatile organic material emitted during processing, cross-linking, vulcanisation or during the lifetime of the cured or crude rubber compound. The group R′ if present is preferably a methyl, ethyl or phenyl group. Alternative substitution groups on Si atom can be based on the following patents WO2004/078813, WO2005/007066, US20090036701, DE10223073 and EP1683801 or US20060161015.

The unsaturated silane can be partially hydrolysed and condensed into oligomers containing siloxane linkages. For most end uses it is preferred that such oligomers still contain at least one hydrolysable group bonded to Si per unsaturated silane monomer unit to enhance coupling of the unsaturated silane with fillers having surface hydroxyl groups.

In the unsaturated silane of the formula:

R″—CH═CH—C(O)X—Y—SiRₐR′₍₃₋ₐ₎ (I) or

R″—C≡C—C(O)X—Y—SiRₐR′₍₃₋ₐ₎ (II)

the spacer linkage Y can in general be a divalent organic group comprising at least one carbon atom, for example an alkylene group such as methylene, ethylene or propylene, or an arylene group. However, as hereinbefore described Y may also include heteroatoms such as O, S and N. When the group R″ represents hydrogen and Y is an alkylene linkage, the moiety R″—CH═CH—C(O)X—Y— in the unsaturated silane (I) is an acryloxyalkyl group. We have found that acryloxyalkylsilanes graft to epoxidised rubber more readily than other unsaturated silane, e.g., methacryloxyalkylsilanes.

Examples of preferred acryloxyalkylsilanes are γ-acryloxypropyltrimethoxysilane, γ-acryloxypropylmethyldimethoxysilane, γ-acryloxypropyldimethylmethoxysilane, γ-acryloxypropyltriethoxysilane, γ-acryloxypropylmethyldiethoxysilane, γ-acryloxypropyldimethylethoxysilane, α-acryloxymethyltrimethoxysilane, α-acryloxymethylmethyldimethoxysilane, α-acryloxymethyldimethylmethoxysilane, α-acryloxymethyltriethoxysilane, α-acryloxymethylmethyldiethoxysilane, α-acryloxymethyldimethylethoxysilane. γ-acryloxypropyltrimethoxysilane can be prepared from allyl acrylate and trimethoxysilane by the process described in U.S. Pat. No. 3,179,612. Similarly γ-acryloxypropyltriethoxysilane, γ-acryloxypropylmethyldimethoxysilane and γ-acryloxypropyldimethylmethoxysilane can be prepared from allyl acrylate and triethoxysilane, methyldimethoxysilane or dimethylmethoxysilane respectively. Acryloxymethyltrimethoxysilane or acryloxymethyltriethoxysilane can be prepared from acrylic acid and chloromethyltrimethoxysilane or chloromethyltriethoxysilane by the process described in U.S. Pat. No. 3,179,612.

Alternatives structures are based on the reaction product of (1) a functional silane containing at least one primary or secondary amine or a mercapto-functional silane, e.g. mercaptopropyltriethoxysilane, with (2) an organic moiety containing at least 2 acrylate functions, as produced by Sartomer along WO98/28307 described as di, tri, tetra, penta and hexa functional monomers. As set of example one can prepare the following structures using pentaerythritol-tetraacrylate together with mercaptopropylalkoxysilane or methylaminopropylalkoxysilane or phenylaminopropylalkoxysilane as described in EP450624-B, U.S. Pat. No. 5,532,398 A and EP451709 B:

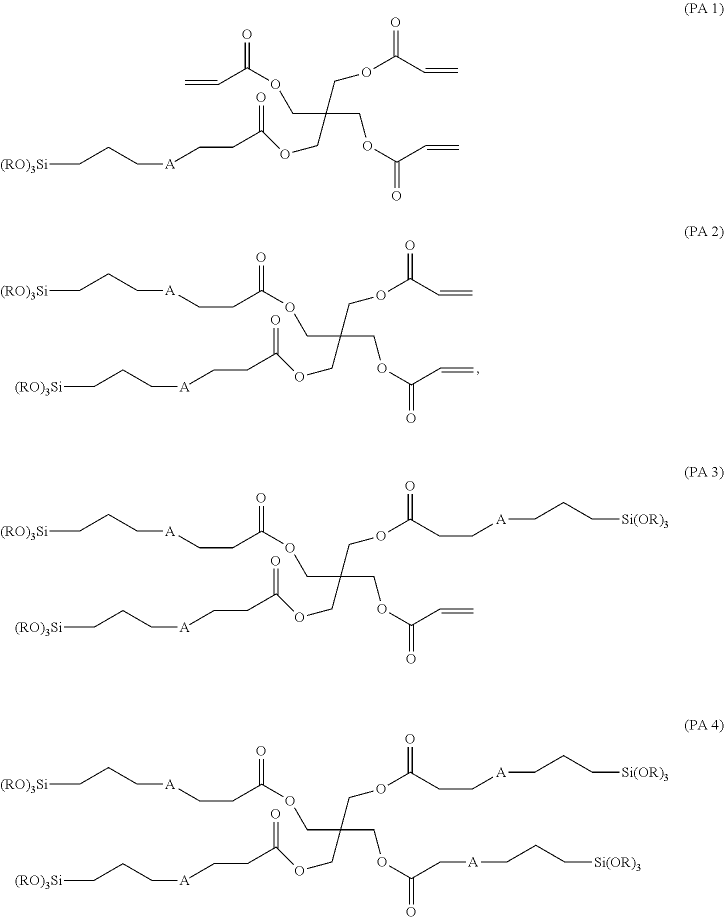

In these formulae (PA1 to PA4) A is selected from S or NR in which R can be H, aryl, alkyl groups, R can alternatively be another alkylsilane. The spacer between A and Si can vary from methyl to undecyl. Each of PA1 to PA4 may be provided in a substantially pure form i.e. approximately 100% PA1, PA2, PA3 or PA4 or may be provided in mixtures containing at least one of PA1, PA2, PA3 or PA4 as the major component and the others as by-products.

To reduce alcohol emission during processing and lifetime of a rubber compound containing PA structures one can use mono or dialkoxysilane instead of trialkoxysilane.

To reduce toxic methanol emission during processing and lifetime, ethoxy silane is preferred over methoxysilane.

As hereinbefore described, the group R″ in the unsaturated silane (I) or (II) may be hydrogen or a group having an electron withdrawing effect with respect to the —CH═CH— or —C≡C— bond. One such electron withdrawing group suitable for the present invention is of the formula —C(O)X—Y—SiRₐR′₍₃₋ₐ₎. Alternatively the electron withdrawing group R″ can be of the form —C(O)OH or —C(O)XR*, where R* is an alkyl group.

When the electron withdrawing group is —C(O)X—Y—SiRₐR′₍₃₋ₐ₎, the resulting unsaturated silane (silane(III)) can thus be of the form:

R″—CH═CH—C(O)X—Y—SiRₐR′₍₃₋ₐ₎ (I) or

R″—C≡C—C(O)X—Y—SiRₐR′₍₃₋ₐ₎ (II)

In this instance therefore unsaturated silane (III) can comprise a bis(trialkoxysilylalkyl) fumarate (trans-isomer) and/or a bis(trialkoxysilylalkyl) maleate (cis-isomer). Examples are bis-(γ-trimethoxysilylpropyl) fumarate and bis-(γ-trimethoxysilylpropyl)maleate. Their preparation is described in U.S. Pat. No. 3,179,612.

When the electron withdrawing group R″ is in the form —C(O)OH or —C(O)XR*, where R* is an alkyl group, the unsaturated silane can be a mono(trialkoxysilylalkyl) fumarate and/or a mono(trialkoxysilylalkyl)maleate, or can be a trialkoxysilylalkyl ester of an alkyl monofumarate and/or an alkyl monomaleate.

The unsaturated silane can also be of the form RₐR′₍₃₋ₐ₎Si—Y—X(O)C—C≡C—C(O)X—Y—SiRₐR′₍₃₋ₐ₎; an example is bis-(γ-trimethoxysilylpropyl)-2-butynedioate. Alternatively the bis-silane of the formula

R″—CH═CH—C(O)X—Y—SiRₐR′₍₃₋ₐ₎ (I) or

R″—C≡C—C(O)X—Y—SiRₐR′₍₃₋ₐ₎ (II)

may be asymmetrical, e.g. with Y, R and/or R′ being different on each side of the molecule.

In general, all unsaturated silanes which are silylalkyl esters of an unsaturated acid can be prepared from the unsaturated acid, for example acrylic, maleic, fumaric, propynoic or butyne-dioic acid, by reaction of the corresponding carboxylate salt with the corresponding chloroalkylalkoxysilane. In a first step, the alkali salt of the carboxylic acid is formed either by reaction of the carboxylic acid with alkali alkoxide in alcohol, as described e.g. in U.S. Pat. No. 4,946,977, or by reaction of the carboxylic acid with aqueous base and subsequent removal of the water via azeotropic distillation, as described e.g. in WO-2005/103061. A trialkyl ammonium salt of the carboxylic acid can be formed by direct reaction of the free carboxylic acid with trialkyl amine, preferentially tributyl amine or triethyl amine as described in U.S. Pat. No. 3,258,477 or U.S. Pat. No. 3,179,612. In a second step the carboxylic acid salt is then reacted via nucleophilic substitution reaction with the chloroalkylalkoxysilane under formation of the alkali chloride or trialkylammonium chloride as a by-product. This reaction can be performed with the chloroalkylalkoxysilane under neat condition or in solvents such as benzene, toluene, xylene, or a similar aromatic solvent, as well as methanol, ethanol, or another alcohol-type solvent. It is preferably to have a reaction temperature within the range of 30 to 180° C., preferably within the range of 100 to 160° C. In order to speed up this replacement reaction, phase transfer catalysts of various kinds can be used. Preferable phase transfer catalysts are the following: tetrabutylammonium bromide (TBAB), trioctylmethylammonium chloride, Aliquat® 336 (Cognis GmbH) or similar quaternary ammonium salts (as e.g. used in U.S. Pat. No. 4,946,977), tributylphosphonium chloride (as e.g. used in U.S. Pat. No. 6,841,694), guanidinium salts (as e.g. used in EP0900801) or cyclic unsaturated amines as 1,8-diazabicyclo[5.4.0]undeca-7-ene (DBU, as e.g. used in WO2005/103061). If necessary, the following polymerization inhibitors can be used throughout preparation and/or purification steps: hydroquinones, phenol compounds such as methoxyphenol and 2,6-di-t-butyl 4-methylphenol, phenothiazine, p-nitrosophenol, amine-type compounds such as e.g. N,N′-diphenyl-p-phenylenediamine or sulfur containing compounds as described in but not limited to the patents cited above.

Preparation methods for the formation of thiocarboxylate —C(═O)—S— compounds have been extensively described in form of the preparation of blocked mercaptosilanes in e.g. WO2004/078813, WO2005/007066, and US20090036701. However the usage of compounds in rubber compounding processes containing an O-unsaturated carbonyl including a carbon-carbon double bond next to the carbonyl group has been explicitly ruled out in e.g. EP0958298, EP1270581, US20020055564 or WO03/091314 because the unsaturation α,□β- to the carbonyl group of the thioester has the undesirable ability to polymerize during the compounding process or during storage. However, in the present application the “undesired” high reactivity of the unsaturated group next to the electron withdrawing group is a key aspect. The method for preparing such silanes can be therefore found, in those patents

PA type of structures and mixtures thereof can be obtained using a batch or continuous process via Michael addition reaction of a functional silane (mercapto or amino) together with a organic molecule containing at least 2 acrylate moiety following the reaction pathway below as set of example but limiting to the starting material proposed and to the structures obtained, as described by B. C. Ranu and S. Banerjee, Tetrahedron Letters, vol. 48, Iss. 1, pp. 141-143 (2007). In case the silane is a mercapto-functional silane, a catalyst might be used to enhance the reactivity:

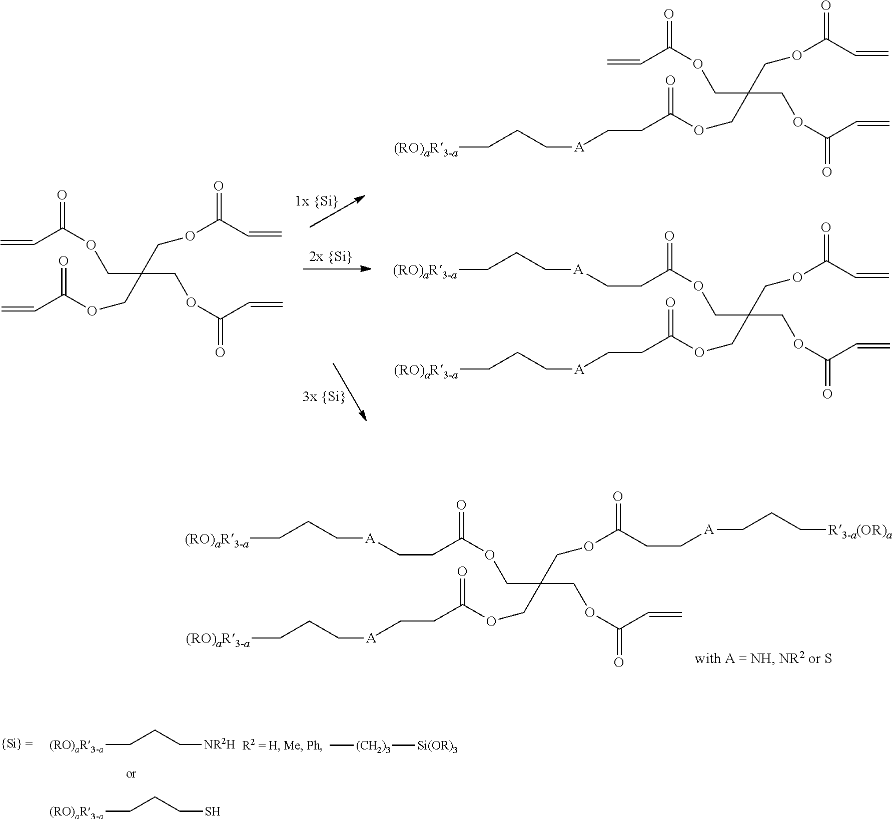

Advantageously those structures will be prepared using a continuous process. To reduce the polydispersity of structure the continuous process should be performed in small tubes, ideally microreactor or micro-channels can be used.

The introduction of larger alcohol as well as alkyl(poly)ether substituents at the silyl functionality starting from chloro-, methoxy and ethoxysilanes are described e.g. in DE10223073 and EP1683801 or US20060161015. The exchange of monoalkoxy substituents with polyols such as e.g. 2-methyl-1,3-propanediol under formation of even oligomeric silane systems has been described e.g. in WO2008/042418.

Blends of unsaturated silanes can be used, for example a blend of γ-acryloxypropyltrimethoxysilane with acryloxymethyltrimethoxysilane or acryloxypropyltriethoxysilane or a blend of γ-acryloxypropyltrimethoxysilane and/or acryloxymethyltrimethoxysilane with an acryloxysilane containing 1 or 2 Si-alkoxy groups such as acryloxymethylmethyldimethoxysilane, acryloxymethyldimethylmethoxysilane, γ-acryloxypropylmethyldimethoxysilane or γ-acryloxypropyldimethylmethoxysilane.

Alternatively the unsaturated silane can be supported on carriers, e.g. carbon black, silica, calcium carbonate, waxes or a polymer. This can be useful for handling the material in a plant and also can lead to improve silane solubility/compatibility with rubbers.

The epoxidised rubber can be natural rubber. We have found that the unsaturated silanes of the invention graft readily to natural rubber and also acts as an effective coupling agent in a curable filled natural rubber composition.

The elastomer and the unsaturated silane can be reacted by various procedures. Although some reaction occurs at ambient temperature, the elastomer and the unsaturated silane are preferably heated together at a temperature of at least 80° C., more preferably to a temperature between 90°-200° C., most preferably between 120° C. and 180° C. The elastomer and silane can be mixed by pure mechanical mixing, followed if desired by a separate heating step, but mixing and heating are preferably carried out together so that the elastomer is subjected to mechanical working while it is heated.

The elastomer and the unsaturated silane can be reacted in the presence of a catalyst which accelerates the ene-addition reaction between the activated unsaturated silane and the diene containing rubber polymer, for example a Lewis Acid such as boron triacetate. Use of such a catalyst can reduce the temperature of the thermo-mechanical processing required to effect reaction between the elastomer and the unsaturated silane. This catalyst can also help to disperse further the filler. The catalyst can control the number of links created during the mixing phase to optimize the torque, the grafting and, when hydroxyl containing filler is present, its dispersion. However the epoxidised rubber and the unsaturated silanes according to the invention react readily at the temperatures conventionally used for thermomechanical kneading of rubber, and it may be desirable to avoid catalyst residues in the grafted elastomer.

The catalyst such as a Lewis acid can also be added during the productive phase in order to accelerate the cure behaviour under heating of the semi-finished article.

When preparing a filled rubber composition, the elastomer and the unsaturated silane can be reacted and then mixed with the filler, but the filler is preferably present during the reaction between the elastomer and the unsaturated silane. The elastomer, the silane and the filler can all be loaded to the same mixer and mixed while being heated, for example by thermo-mechanical kneading. Alternatively the filler can be pre-treated with the unsaturated silane and then mixed with the elastomer, preferably with heating. When the unsaturated silane is present during thermo-mechanical kneading of the epoxidised rubber and the filler, it reacts with the elastomer to form a modified epoxidised rubber and also acts as a coupling agent bonding the filler to the elastomer.

The filler is preferably a reinforcing filler. Examples of reinforcing fillers are silica, silicic acid, carbon black, or a mineral oxide of aluminous type such as alumina trihydrate or an aluminium oxide-hydroxide, or a silicate such as an aluminosilicate, or a mixture of these different fillers.

The use of an unsaturated silane according to the invention is particularly advantageous in a curable elastomer composition comprising a filler containing hydroxyl groups, particularly in reducing the mixing energy required for processing the rubber composition and improving the performance properties of products formed by curing the rubber composition. The hydroxyl-containing filler can for example be a mineral filler, particularly a reinforcing filler such as a silica or silicic acid filler, as used in white tyre compositions, or a metal oxide such as a mineral oxide of aluminous type such as alumina trihydrate or an aluminium oxide-hydroxide, or carbon black pre-treated with a alkoxysilane such as tetraethyl orthosilicate, or a silicate such as an aluminosilicate or clay, or cellulose or starch, or a mixture of these different fillers.

The reinforcing filler can for example be any commonly employed siliceous filler used in rubber compounding applications, including pyrogenic or precipitated siliceous pigments or aluminosilicates. Precipitated silicas are preferred, for example those obtained by the acidification of a soluble silicate, e.g., sodium silicate. The precipitated silica preferably has a BET surface area, as measured using nitrogen gas, in the range of about 20 to about 600 m²/g, and more usually in a range of about 40 or 50 to about 300 m²/g. The BET method of measuring surface area is described in the Journal of the American Chemical Society, Volume 60, Page 304 (1930). The silica may also be typically characterized by having a dibutylphthalate (DBP) value in a range of about 100 to about 350 cm³/100 g, and more usually about 150 to about 300 cm³/100 g, measured as described in ASTM D2414. The silica, and the alumina or aluminosilicate if used, preferably have a CTAB surface area in a range of about 100 to about 220 m²/g (ASTM D3849). The CTAB surface area is the external surface area as evaluated by cetyl trimethylammonium bromide with a pH of 9. The method is described in ASTM D 3849.

Various commercially available silicas may be considered for use in elastomer compositions according to this invention such as silicas commercially available from Rhodia with, for example, designations of Zeosil® 1165 MP, 1115 MP, or HRS 1200 MP; 200 MP premium, 80GR or silicas available from PPG Industries under the Hi-Sil trademark with designations Hi-Sil® EZ150G, 210, 243, etc; silicas available from Degussa AG with, for example, designations VN3, Ultrasil® 7000 and Ultrasil® 7005, and silicas commercially available from Huber having, for example, a designation of Hubersil® 8745 and Hubersil® 8715. Treated precipitated silicas can be used, for example the aluminium-doped silicas described in EP-A-735088.

If alumina is used in the elastomer compositions of the invention, it can for example be natural aluminium oxide or synthetic aluminium oxide (Al₂O₃) prepared by controlled precipitation of aluminium hydroxide. The reinforcing alumina preferably has a BET surface area from 30 to 400 m²/g, more preferably between 60 and 250 m²/g, and an average particle size at most equal to 500 nm, more preferably at most equal to 200 nm. Examples of such reinforcing aluminas are the aluminas A125, CR125, D65CR from Baïkowski or the neutral, acidic, or basic Al₂O₃ that can be obtained from the Aldrich Chemical Company. Neutral alumina is preferred.

Examples of aluminosilicates which can be used in the elastomer compositions of the invention are Sepiolite, a natural aluminosilicate which might be obtained as PANSIL® from Tolsa S.A., Toledo, Spain, and SILTEG®, a synthetic aluminosilicate from Degussa GmbH.

The hydroxyl-containing filler can alternatively be talc, magnesium dihydroxide or calcium carbonate, or a natural organic filler such as cellulose fibre or starch. Mixtures of mineral and organic fillers can be used, as can mixtures of reinforcing and non-reinforcing fillers.

The filler can additionally or alternatively comprise a filler which does not have hydroxyl groups at its surface, for example a reinforcing filler such as carbon black and/or a non-reinforcing filler such as calcium carbonate.

The reaction between the epoxidised rubber and the unsaturated silane (I) or (II) can be carried out as a batch process or as a continuous process using any suitable apparatus.

Continuous processing can be effected in an extruder such as a single screw or twin screw extruder. The extruder is preferably adapted to mechanically work, that is to knead or compound, the materials passing through it, for example a twin screw extruder. One example of a suitable extruder is that sold under the trade mark ZSK from Coperion Werner Pfeidener. The extruder preferably includes a vacuum port shortly before the extrusion die to remove any unreacted silane. The residence time of the epoxidised rubber and the unsaturated silane at above 100° C. in the extruder or other continuous reactor is generally at least 0.5 minutes and preferably at least 1 minute and can be up to 15 minutes. More preferably the residence time is 1 to 5 minutes.

A batch process can for example be carried out in an internal mixer such as a Banbury mixer or a Brabender Plastograph™ 350S mixer equipped with roller blades. An external mixer such as a roll mill can be used for either batch or continuous processing. In a batch process, the elastomer and the unsaturated silane are generally mixed together at a temperature above 100° C. for at least 1 minute and can be mixed for up to 20 minutes, although the time of mixing at high temperature is generally 2 to 10 minutes.

The elastomer compositions are preferably produced using the conventional two successive preparation phases of mechanical or thermo-mechanical mixing or kneading (“non-productive” phase) at high temperature, followed by a second phase of mechanical mixing (“productive” phase) at lower temperature, typically less than 110° C., for example between 40° C.-100° C., during which the cross-linking and vulcanization systems are incorporated.

During the non productive phase, the unsaturated silane, the epoxidised rubber and the filler are mixed together. Mechanical or thermo-mechanical kneading occurs, in one or more steps, until a maximum temperature of 110°-190° C. is reached, preferably between 130°-180° C. When the apparent density of the reinforcing inorganic filler is low (generally the case for silica), it may be advantageous to divide the introduction thereof into two or more parts in order to improve further the dispersion of the filler in the rubber. The total duration of the mixing in this non-productive phase is preferably between 2 and 10 minutes.

Compositions comprising the modified elastomer produced by reaction with the unsaturated silane according to the invention can be cured by various mechanisms. The curing agent for the modified elastomer can be a conventional rubber curing agent such as a sulfur vulcanizing agent. Alternatively the modified elastomer can be cured by a radical initiator such as a peroxide. Alternatively the modified elastomer can be cured by exposure to moisture, preferably in the presence of a silanol condensation catalyst. The hydrolysable silane groups grafted onto the elastomer can react with each other to crosslink the elastomer and/or can be further reacted with a polar surface, filler or polar polymer.

For many uses curing by a conventional sulfur vulcanizing agent is preferred. Examples of suitable sulfur vulcanizing agents include, for example, elemental sulfur (free sulfur) or sulfur donating vulcanizing agents, for example, an amine disulfide, polymeric polysulfide or sulfur olefin adducts which are conventionally added in the final, productive, rubber composition mixing step. Preferably, in most cases, the sulfur vulcanizing agent is elemental sulfur. Sulfur vulcanizing agents are used in an amount ranging from about 0.4 to about 8% by weight based on elastomer, preferably 1.5 to about 3%, particularly 2 to 2.5%.

Accelerators are generally used to control the time and/or temperature required for vulcanization and to improve the properties of the vulcanized elastomer composition. In one embodiment, a single accelerator system may be used, i.e., primary accelerator. Conventionally and preferably, a primary accelerator(s) is used in total amounts ranging from about 0.5 to about 4% by weight based on elastomer, preferably about 0.8 to about 1.5%. In another embodiment, combinations of a primary and a secondary accelerator might be used with the secondary accelerator being used in smaller amounts of about 0.05 to about 3% in order to activate and to improve the properties of the vulcanisate. Delayed action accelerators may be used which are not affected by normal processing temperatures but produce a satisfactory cure at ordinary vulcanization temperatures. Vulcanization retarders can also be used, e.g. phthalic anhydride, benzoic acid or cyclohexylthiophthalimide. Suitable types of accelerators that may be used in the present invention are amines, disulfides, guanidines, thioureas, thiazoles, for example mercaptobenzothiazole, thiurams, sulfenamides, dithiocarbamates, thiocarbonates, and xanthates. Preferably, the primary accelerator is a sulfenamide. If a second accelerator is used, the secondary accelerator is preferably a guanidine, dithiocarbamate or thiuram compound.

In case the curing system is composed of sulphur, the vulcanization, or curing, of a rubber product such as a tyre or tyre tread is carried out in known manner at temperatures preferably between 130°-200° C., under pressure, for a sufficiently long period of time. The required time for vulcanization may vary for example between 2 and 30 minutes.

In one preferred procedure the epoxidised rubber and the unsaturated silane and possibly the filler are mixed together above 100° C. in an internal mixer or extruder.

By way of example, the first (non-productive) phase is effected in a single thermomechanical step during which in a first phase the reinforcing filler, the unsaturated silane and the elastomer are mixed in a suitable mixer, such as a conventional internal mixer or extruder, then in a second phase, for example after one to two minutes' kneading, any complementary covering agents or processing agents and other various additives, with the exception of the vulcanization system, are introduced into the mixer.

A second step of thermomechanical working may be added in this internal mixer, after the mixture has dropped and after intermediate cooling to a temperature preferably less than 100° C., with the aim of making the compositions undergo complementary thermomechanical treatment, in particular in order to improve further the dispersion, in the elastomeric matrix, of the reinforcing inorganic filler. The total duration of the kneading, in this non-productive phase, is preferably between 2 and 10 minutes.

After cooling of the mixture thus obtained, the vulcanization system is then incorporated at low temperature, typically on an external mixer such as an open mill, or alternatively on an internal mixer (Banbury type). The entire mixture is then mixed (productive phase) for several minutes, for example between 2 and 10 minutes.

Any other additives such as a grafting catalyst can be incorporated either in the “non productive” phase or in the productive phase.

The curable rubber composition can contain a coupling agent other than the unsaturated silane, for example a trialkoxy, dialkoxy or monoalkoxy silane coupling agent, particularly a sulfidosilane or mercaptosilane or an azosilane, acrylamidosilane, blocked mercaptosilane, aminosilane alkylsilane or alkenylsilane having 1 to 20 carbon atoms in the alkyl group and 1 to 6 carbon atoms in the alkoxy group. Examples of preferred coupling agents include a bis(trialkoxysilylpropyl)disulfane or tetrasulfane as described in U.S. Pat. No. 5,684,171, such as bis(triethoxysilylpropyl)tetrasulfane or bis(triethoxysilylpropyl)disulfane, or a bis(dialkoxymethylsilylpropyl)disulfane or tetrasulfane such as bis(methyldiethoxysilylpropyl)tetrasulfane or bis(methyldiethoxysilylpropyl)disulfane, or a bis(dimethylethoxysilylpropyl)oligosulfane such as bis(dimethylethoxysilylpropyl)tetrasulfane or bis(dimethylethoxysilylpropyl)disulfane, or a bis(dimethylhydroxysilylpropyl)polysulfane as described in U.S. Pat. No. B1-6,774,255, or a dimethylhydroxysilylpropyl dimethylalkoxysilylpropyl oligosulfane as described in WO-A-2007/061550, or a mercaptosilane such as triethoxysilylpropylmercaptosilane. Such a coupling agent promotes bonding of the filler to the organic elastomer, thus enhancing the physical properties of the filled elastomer. The filler can be pre-treated with the coupling agent or the coupling agent can be added to the mixer with the elastomer and filler and the unsaturated silane according to the invention. We have found that use of an unsaturated silane (I) or (II) according to the invention in conjunction with such a coupling agent can reduce the mixing energy required for processing the elastomer composition and improve the performance properties of products formed by curing the elastomer composition compared to compositions containing the coupling agent with no such unsaturated silane.

The curable rubber composition can contain a covering agent other than the unsaturated silane, for example a trialkoxy, dialkoxy or monoalkoxy silane covering agent, particularly n-octyltriethoxysilane or 1-hexadecyltriethoxysilane, or hexamethyldisilazane or a polysiloxane covering agent such as a hydroxyl-terminated polydimethylsiloxane, hydroxyl-terminated polymethylphenylsiloxane, or a linear polyfunctionalsiloxane, or a silicone resin. The covering agent can alternatively be an aryl-alkoxysilane or aryl-hydroxysilane, a tetraalkoxysilane such as tetraethoxysilane, or a polyetherpolyol such as polyethylene glycol, an amine such as a trialkanolamine. The filler can be pre-treated with the covering agent or the coupling agent can be added to the mixer with the elastomer and filler and the unsaturated silane according to the invention. We have found that use of an unsaturated silane (I) or (II) according to the invention in conjunction with such a covering agent can reduce the mixing energy required for processing the elastomer composition and improve the performance properties of products formed by curing the elastomer composition compared to compositions containing the covering agent with no such unsaturated silane.

The elastomer composition can be compounded with various commonly-used additive materials such as processing additives, for example oils, resins including tackifying resins, silicas, and plasticizers, fillers, pigments, fatty acid, zinc oxide, waxes, antioxidants and antiozonants, heat stabilizers, UV stabilizers, dyes, pigments, extenders and peptizing agents.

Typical amounts of tackifier resins, if used, comprise about 0.5 to about 10% by weight based on elastomer, preferably 1 to 5%. Typical amounts of processing aids comprise about 1 to about 50% by weight based on elastomer. Such processing aids can include, for example, aromatic, naphthenic, and/or paraffinic processing oils.

Typical amounts of antioxidants comprise about 1 to about 5% by weight based on elastomer. Representative antioxidants may be, for example, N-1,3-dimethylbutyl-N-phenyl-para-phenylenediamine, sold as “Santoflex 6-PPD” (trade mark) from Flexsys, diphenyl-p-phenylenediamine and others, for example those disclosed in The Vanderbilt Rubber Handbook (1978), Pages 344 through 346. Typical amounts of antiozonants also comprise about 1 to 5% by weight based on elastomer.

Typical amounts of fatty acids, if used, which can include stearic acid or zinc stearate, comprise about 0.1 to about 3% by weight based on elastomer. Typical amounts of zinc oxide comprise about 0 to about 5% by weight based on elastomer alternatively 0.1 to 5%.

Typical amounts of waxes comprise about 1 to about 5% by weight based on elastomer. Microcrystalline and/or crystalline waxes can be used.

Typical amounts of peptizers comprise about 0.1 to about 1% by weight based on elastomer. Typical peptizers may for example be pentachlorothiophenol or dibenzamidodiphenyl disulfide.

The modified elastomer composition containing a curing agent such as a vulcanizing system is shaped and cured into an article. The elastomer composition can be used to produce tyres, including any part thereof such as the bead, apex, sidewall, inner liner, tread or carcass. The elastomer composition can alternatively be used to produce any other engineered rubber goods, for example bridge suspension elements, hoses, belts, shoe soles, anti seismic vibrators, and dampening elements. The elastomer composition can be cured in contact with reinforcing elements such as cords, for example organic polymer cords such as polyester, nylon, rayon, or cellulose cords, or steel cords, or fabric layers or metallic or organic sheets.

The modified elastomer composition containing a vulcanizing system can for example be calendered, for example in the form of thin slabs (thickness of 2 to 3 mm) or thin sheets of rubber in order to measure its physical or mechanical properties, in particular for laboratory characterization, or alternatively can be extruded to form rubber profiled elements used directly, after cutting or assembling to the desired dimensions, as a semi-finished product for tyres, in particular as treads, plies of carcass reinforcements, sidewalls, plies of radial carcass reinforcements, beads or chaffers, inner tubes or air light internal rubbers for tubeless tyres.

As an alternative to curing by a sulfur vulcanizing system, the modified elastomer composition can be cured by a peroxide. Examples are di(tert-butyl)peroxide; t-butylcumyl peroxide; dicumyl peroxide; benzoyl peroxide; 1,1′-di(t-butylperoxy)-3,3,5-trimethylcyclohexane; 2,5-dimethyl-2,5-di(t-butylperoxy)hexyne; 2,5-dimethyl-2,5-di(t-butylperoxy)hexane; α,α′-di(t-butylperoxy)-m/p-diisopropylbenzene; and n-butyl-4,4′-di(tert-butylperoxy)valerate.

This invention relates to the use of activated unsaturated functional silane to graft to epoxidised rubber without any radical initiator to help the grafting. However, vulcanization can still be done using peroxides. Heat or UV radiation can be used to vulcanise the rubber in order to activate the peroxide. Heat activation of the peroxide is the preferred way, for example with temperature from 100 to 200° C. for a time comprised between 1 to 90 minutes, preferably 5 to 20 minutes.

A second alternative to sulfur and peroxide cure is the use of the alkoxysilane groups of the obtained grafted polymer. If the grafted elastomer is cross-linked by exposure to moisture in the presence of a silanol condensation catalyst, any suitable condensation catalyst may be used. These include protic acids, Lewis acids, organic and inorganic bases, transition metal compounds, metal salts and organometallic complexes.

Preferred catalysts include organic tin compounds, particularly organotin salts and especially diorganotin dicarboxylate compounds such as dibutyltin dilaurate, dioctyltin dilaurate, dimethyltin dibutyrate, dibutyltin dimethoxide, dibutyltin diacetate, dimethyltin bisneodecanoate, dibutyltin dibenzoate, dimethyltin dineodeconoate or dibutyltin dioctoate. Alternative organic tin catalysts include triethyltin tartrate, stannous octoate, tin oleate, tin naphthate, butyltintri-2-ethylhexoate, tin butyrate, carbomethoxyphenyl tin trisuberate and isobutyltin triceroate. Organic compounds, particularly carboxylates, of other metals such as lead, antimony, iron, cadmium, barium, manganese, zinc, chromium, cobalt, nickel, aluminium, gallium or germanium can alternatively be used.

The condensation catalyst can alternatively be a compound of a transition metal selected from titanium, zirconium and hafnium, for example titanium alkoxides, otherwise known as titanate esters of the general formula Ti[OR⁵]₄ and/or zirconate esters Zr[OR⁵]₄ where each R⁵ may be the same or different and represents a monovalent, primary, secondary or tertiary aliphatic hydrocarbon group which may be linear or branched containing from 1 to 10 carbon atoms. Preferred examples of R⁵ include isopropyl, tertiary butyl and a branched secondary alkyl group such as 2,4-dimethyl-3-pentyl. Alternatively, the titanate may be chelated with any suitable chelating agent such as acetylacetone or methyl or ethyl acetoacetate, for example diisopropyl bis(acetylacetonyl)titanate or diisopropyl bis(ethylacetoacetyl)titanate.

The condensation catalyst can alternatively be a protonic acid catalyst or a Lewis acid catalyst. Examples of suitable protonic acid catalysts include carboxylic acids such as acetic acid and sulphonic acids, particularly aryl sulphonic acids such as dodecylbenzenesulphonic acid. A “Lewis acid” is any substance that will take up an electron pair to form a covalent bond, for example, boron trifluoride, boron trifluoride monoethylamine complex, boron trifluoride methanol complex, boron triacetate, metal alkoxide (e.g. Al(OEt)₃, Al(OiPr)₃), NaF, FeCl₃, AlCl₃, ZnCl₂, ZnBr₂ or catalysts of formula MR⁴_{f}X_{g} where M is B, Al, Ga, In or TI, each R⁴ is independently the same or different and represents a monovalent aromatic hydrocarbon radical having from 6 to 14 carbon atoms, such monovalent aromatic hydrocarbon radicals preferably having at least one electron-withdrawing element or group such as —CF₃, —NO₂ or —CN, or substituted with at least two halogen atoms; X is a halogen atom; f is 1, 2, or 3; and g is 0, 1 or 2; with the proviso that f+g=3. One example of such a catalyst is B(C₆F₅)₃.

An example of a base catalyst is an amine or a quaternary ammonium compound such as tetramethylammonium hydroxide, or an aminosilane. Amine catalysts such as laurylamine can be used alone or can be used in conjunction with another catalyst such as a tin carboxylate or organotin carboxylate.

The silane condensation catalyst is typically used at 0.005 to 1.0% by weight based on the modified epoxidised rubber. For example a diorganotin dicarboxylate is preferably used at 0.01 to 0.1% by weight based on the elastomer.

When curing a modified epoxidised rubber by exposure to moisture, the modified elastomer is preferably shaped into an article and subsequently cross-linked by moisture. In one preferred procedure, the silanol condensation catalyst can be dissolved in the water used to crosslink the grafted polymer. For example an article shaped from grafted polyolefin can be cured by water containing a carboxylic acid catalyst such as acetic acid, or containing a diorganotin carboxylate.

Alternatively or additionally, the silanol condensation catalyst can be incorporated into the modified elastomer before the modified elastomer is shaped into an article. The shaped article can subsequently be cross-linked by moisture. The catalyst can be mixed with the epoxidised rubber before, during or after the grafting reaction.

A silanol condensation catalyst can be used in addition to other curing means such as vulcanization by sulphur. In this case, the silanol condensation catalyst can be incorporated either in the “non productive” phase or in the productive phase of the preferred vulcanization process described above.

When curing is done using alkoxysilane groups of the grafted elastomer, care should be taken when forming a cured elastomer article to avoid exposure of the silane and catalyst together to moisture, or of the composition of silane-modified elastomer and catalyst to moisture before its final shaping into the desired article.

The modified epoxidised rubber according to the invention has improved adhesion both to fillers mixed with the elastomer and silane during the grafting reaction and to substrates to which the modified epoxidised rubber is subsequently applied. Improved adhesion to fillers results in better dispersion of the fillers during compounding. Substrates to which the modified epoxidised rubber is applied include metal cords and fabrics and organic polymer cords and fabrics which are incorporated into the structure of a finished article, for example a tyre, made from the modified epoxidised rubber. Improved adhesion to such substrates leads to a finished article having improved mechanical and wear properties.

The ability of the unsaturated silanes of the invention to react with an epoxidised rubber in the absence of any free radical initiator allows formation of a modified elastomer, especially modified natural rubber, without polymer degradation, leading to improved rubber performance, for example improved mechanical properties and/or resistance to thermal degradation, compared to a epoxidised rubber grafted in the presence of a free radical initiator such as peroxide. When the modified elastomer is used to manufacture tire treads, improved mechanical properties can give improved tyre properties such as decreased rolling resistance, better tread wear and improved wet skid performance. Preferably the unsaturated silane (I) comprises gamma-acryloxypropyltrimethoxysilane, gamma acryloxymethyltrimethoxysilane, gamma-acryloxypropyltriethoxysilane, alpha acryloxymethyltriethoxysilane, bis-(gamma trimethoxysilylpropyl)-fumarate and/or bis-(gamma triethoxysilylpropyl)-fumarate. Preferably the silane is obtained by mixing pentaerythritol tetraacrylate and N-methyl-aminopropyltriethoxysilane, N-phenyl-aminopropyltriethoxysilane, bis-(triethoxysilylpropyl)amine or mercaptopropyltriethoxysilane in mole ratios between 1:1 to 1:3.5 (acrylate:silane). Preferably the silane is obtained by mixing trimethylolpropane triacrylate and N-methyl-aminopropyltriethoxysilane or N-phenyl-aminopropyltriethoxysilane or mercaptopropyltriethoxysilane in mole ratios between 1:1 to 1:2.5. Preferably, the unsaturated silane (I) or (II) is present at 0.5 to 15.0% by weight based on the epoxidised rubber during the reaction. Preferably the epoxidised rubber composition is cured by sulfur, a sulfur compound or a peroxide. The curable epoxidised rubber composition can be used in the production of tyres or any parts thereof or engineered rubber goods, belts, or hoses.

The invention is illustrated by the following Examples in which parts and percentages are by weight.

### EXAMPLES

Epoxidised Natural rubber was reacted with an unsaturated silane in the presence of silica filler using the formulations, in parts per hundred parts of rubber (parts), shown in Table 1 from the following ingredients:
ENR25 —Epoxidised Natural Rubber with an epoxy content of 25 mole percent in respects with total unsaturation
Silica—Zeosil® 1165 MP from Rhodia
Silane 1—bis-(triethoxysilylpropyl)-tetrasulfane, Z-6940 from Dow Corning
Silane 2—Acryloxypropyltriethoxysilane
ACST—Stearic Acid
ZnO—Zinc Oxide
6PPD—N-1,3-dimethylbutyl-N-phenyl-para-phenylenediamine (“Santoflex® 6-PPD”)
S—Elemental sulfur
CBS—N-cyclohexyl-2-benzothiazyl sulfenamide (“Santocure® CBS” from Flexsys)
N330—Conventional Carbon Black according to ASTM D1765

In a comparative example C1, the ENR25 was compounded with silica without silane in a tyre tread formulation.

In a comparative example C2, the ENR25 was compounded with silica with Z-6940 silane in a tyre tread formulation.

In all examples, a small amount of carbon black was incorporated to benefit from its protective action. Silica content for example 1 was kept at the same level as in comparative examples C1 and C2.

TABLE 1

| | Example | | |
|---|---|---|---|
| Ingredients | C1 | C2 | 1 |
| ENR25 | 100 | 100 | 100 |
| Silica - Z1165MP | 50 | 50 | 50 |
| Silane 1 | | 4 | |
| Silane 2 | | | 4.5 |
| Nytex 820 | 15 | 15 | 15 |
| AcSt | 2 | 2 | 2 |
| ZnO | 2.5 | 2.5 | 2.5 |
| 6PPD | 1.9 | 1.9 | 1.9 |
| Carbon black N330 | 3 | 3 | 3 |
| S | 2 | 2 | 2 |
| CBS | 1.1 | 1.1 | 1.1 |

The compounding of the natural rubber, filler and silane (non-productive phase 1) was carried out using thermomechanical kneading in a Banbury mixer. The procedure was as shown in Table 2, which indicates the time of addition of various ingredients and the estimated temperature of the mixture at that time measured with the internal thermocouple from the mixer. The temperature at the end of mixing was measured inside the rubber after dumping it from the mixer.

TABLE 2

| | Time in seconds | | | | |
|---|---|---|---|---|---|
| | 0 | 90 | 240 | 300 | 420 |
| Ingredient | ENR 25 | 4/5 Filler (+ | 1/5 filler + | Stearic acid | End |
| | | silane) + | Oil | | mixing |
| | | N330 | | | |
| Mixer | 80 | 100 | 120 | 160 | 150-160 |
| internal | | | | | |
| probe | | | | | |
| indicative | | | | | |
| temperature | | | | | |
| (° C.) | | | | | |

The obtained rubber compound from the non-productive phase 2 was then re-milled (non-productive phase 2) using thermomechanical kneading in a Banbury mixer. The procedure was as shown in Table 3, which indicates the time of addition of various ingredients and the estimated temperature of the mixture at that time measured with the internal thermocouple from the mixer. The temperature at the end of mixing was measured inside the rubber after dumping it from the mixer.

TABLE 3

| | Time in seconds | | |
|---|---|---|---|
| | 0 | 60 | 240 |
| Ingredient | Rubber | ZnO + | End |
| | compound from | 6PPD | mixing |
| | NP1 | | |
| Mixer internal probe | 120 | 130 | 150-160 |
| indicative temperature (° C.) | | | |

The modified epoxidised natural rubber composition thus produced was milled on a two-roll mill at a temperature of about 70° C. during which milling the curing agents were added (productive phase). The mixing procedure for the productive phase is shown in Table 4.

TABLE 4

| 2 roll mill process | Number of | Roll distance | |
|---|---|---|---|
| step | passes | (mm) | Time/action |
| Heating up rubber | 5 | 4.0 | NA |
| | 1 | 3.5 | NA |
| | 1 | 3.0 | NA |
| | 1 | 2.5 | NA |
| Mixing rubber and | NA | 2-2.4 | Form a mantle around |
| additives | | | one roll |
| | | | add curing additives |
| | | | within 2.0 minutes |
| | | | cut and turn sheet |
| | | | regularly |
| | | | Stop after 6.0 minutes |
| Sheet formation | 3 | 2.5 | roll up |
| | 2 | 5.1 | Roll on first pass 3-ply |
| | | | for second |
| | 1 | 2.3-2.5 | For final sheet for |
| | | | cutting, moulding and |
| | | | curing |

The modified rubber sheet produced was tested as follows. The results of the tests are shown in Table 5 below.

The rheometry measurements were performed on green compound at 150° C. for 30 minutes using an MONSANTO ODR in accordance with Standard NF ISO 3417. In accordance to this test the torque is followed using small oscillating amplitude (3°) for the biconical rotor included in the test chamber. The rubber composition should fill in completely the test chamber for a valid testing. The change in rheometric torque over time describes the course of stiffening of the composition as a result of the vulcanization reaction. Minimum and maximum torque values, measured in deciNewtonmeter (dNm) are respectively denoted ML and MH time at a % cure (for example 98%) is the time necessary to achieve conversion of a % (for example 98%) of the difference between the minimum and maximum torque values. The difference, denoted MH-ML, between minimum and maximum torque values is also measured. In the same conditions the scorching time for the rubber compositions at 150° C. is determined as being the time in minutes necessary to obtain an increase in the torque of 2 units, above the minimum value of the torque (Time@2dNm scorch S′).

Mechanical and viscoelastic test were performed on cured samples using T98 as the optimal cure time at 150° C.

The tensile tests were performed in accordance with ISO Standard ISO37:1994(F) using tensile specimen ISO 37—type H2. The equipment used was an INSTRON 5564 using a speed of 500 mm/min. The nominal stress (or apparent stresses, in MPa) at 10% elongation (M10), 100% elongation (M100) and elongation (M250 or M300) were measured at 10%, 100% and 250% or 300% of elongation. All these tensile measurements were performed under normal conditions of temperature and relative humidity in accordance with ISO Standard ISO 471. The ratio of M300 to M100 correlates with tread wear resistance of a tyre made from the rubber composition, with an increase in M300/M100 ratio indicating potential better tread wear resistance.

The dynamic properties were measured on a viscoanalyser (Metravib VA3000), in accordance with ASTM Standard D5992.

Complex modulus (E*) and loss factor (tan δ) in compression mode were measured on cured sample (cylindrical specimen of 95 mm² cross section and 14 mm height). Sample was submitted to a pre-load of 10% and to a sinusoidal compression of 2%. Measurements were done at a temperature of 60° C. and 0° C. and a frequency of 10 Hz. A reduction in tan δ max @60° C. is well correlated to a decrease in the rolling resistance of a tire manufactured from the rubber composition. An increase in tan δ@0° C. is well correlated to an increase in the wet grip of a tire manufactured from the rubber composition

The Shore A hardness was measured according to ASTM D2240.

TABLE 5

| Example | | |
|---|---|---|
| C1 | C2 | 1 |

Rheometer @160° C.

| | | | |
|---|---|---|---|
| ML (dNm) | 7.2 | 8.7 | 7.1 |
| MH (dNm) | 61.2 | 68.2 | 61.6 |
| MH − ML (dNm) | 54 | 59.5 | 54.5 |
| Time@98% cure S′ (min) | 14.1 | 8.1 | 16.2 |
| Time@2 dNm scorch S′ (min) | 7.3 | 4.6 | 9.2 |

Dynamic properties, strain sweep compression mode @60° C.

| | | | |
|---|---|---|---|
| E* (Pa) | 4.2 | 5.2 | 4.1 |
| Tan δ max @60° C. | 0.133 | 0.09 | 0.113 |

Dynamic properties, strain sweep compression mode @0° C.

| | | | |
|---|---|---|---|
| Tan δ max @0° C. | 0.243 | 0.355 | 0.354 |

Physical properties

| | | | |
|---|---|---|---|
| M10 (MPa) | 0.48 | 0.6 | 0.45 |
| M100 (MPa) | 2.23 | 2.8 | 2.18 |
| M200 (Mpa) | 5.93 | 7.72 | 6.39 |
| M300 (MPa) | 11.46 | 14.39 | 12.77 |
| M300/M100 | 5.1 | 5.1 | 5.9 |
| Shore A | 50 | 56 | 50 |

The Shore A hardness of the composition of example 1 was similar to that of comparative example C1, as required for tyre application.

The strain sweep results for example 1 showed a reduction in the Tan δ max@60° C., second strain sweep compared to comparative example C1. This is associated with a decrease of the rolling resistance of a tyre made from the rubber composition.

In the physical properties, the M300/M100 ratio for example 1 was increased compared to comparative examples C1 and C2 keeping similar elongation and stress at break, leading to a potential better tread wear resistance.

The strain sweep results for example 1 showed a reduction in the Tan δ max@0° C., second strain sweep compared to comparative example C1. This is associated with an increase of the wet grip of a tyre made from the rubber composition.

1. A process for modifying an epoxidised rubber by reaction with an olefinically unsaturated silane having at least one hydrolysable group bonded to silicon, characterized in that the silane has the formula:
R″—CH═CH—C(O)X—Y—SiRₐR′₍₃₋ₐ₎ (I) or
R″—C≡C—C(O)X—Y—SiRₐR′₍₃₋ₐ₎ (II)
in which R represents a hydrolysable group; R′ represents a hydrocarbyl group having 1 to 6 carbon atoms; a has a value in the range 1 to 3 inclusive; Y represents a divalent organic spacer linkage comprising at least one carbon atom separating the linkage —C(O)X— from the Si atom, and R″ represents hydrogen or a group having an electron withdrawing effect with respect to the —CH═CH— or —C≡C— bond; X is selected from S and O; and the silane is reacted with the epoxidised rubber in the absence of any free radical initiator.

2. The process according to claim 1 characterised in that each group R in the unsaturated silane (I) or (II) is an alkoxy group.

3. The process according to claim 1 characterised in that the unsaturated silane (I) or (II) is partially hydrolyzed and condensed into oligomers.

4. The process according to claim 1 characterised in that the unsaturated silane (I) comprises at least one of γ-acryloxypropyltrimethoxysilane, γ-acryloxymethyltrimethoxysilane, γ-acryloxypropyltriethoxysilane, α-acryloxymethyltriethoxysilane, bis-(γ-trimethoxysilylpropyl)-fumarate and bis-(γ-triethoxysilylpropyl)-fumarate.

5. The process according to claim 1 characterised in that the silane is obtained by mixing a secondary amino-functional alkoxyxysilane or mercapto-propyl-alkoxysilane with a multi-functional organic moiety containing at least 2 acryloxy group.

6. The process according to claim 5 characterised in that the silane is obtained by mixing pentaerythritol tetraacrylate and N-methyl-aminopropyltriethoxysilane, N-phenyl-aminopropyltriethoxysilane, bis-(triethoxysilylpropyl)amine or mercaptopropyltriethoxysilane in mole ratios between 1:1 to 1:3.5 (acrylate:silane).

7. The process according to claim 5 characterised in that the silane is obtained by mixing trimethylolpropane triacrylate and N-methyl-aminopropyltriethoxysilane or N-phenyl-aminopropyltriethoxysilane or mercaptopropyltriethoxysilane in mole ratios between 1:1 to 1:2.5

8. The process according to claim 1 characterised in that the epoxidised rubber is epoxidised natural rubber.

9. The process according to claim 1 characterised in that the formulation contains a synthetic polymer which is a homopolymer or copolymer of a diene monomer.

10. The process according to claim 1 characterized in that the unsaturated silane (I) or (II) is present at 0.5 to 15.0% by weight based on the epoxidised rubber during the reaction.

11. The process according to claim 1 characterized in that the epoxidised rubber and the unsaturated silane (I) or (II) are reacted at a temperature in the range 90° C. to 200° C.

12. The process according to claim 1 characterised in that a filler is present during the reaction of the epoxidised rubber with the unsaturated silane (I) or (II).

13. The process according to claim 12 characterised in that the filler is silica.

14. The process for the production of a rubber article characterized in that a filled epoxidised rubber prepared by the process of claim 12 is shaped and cured.

15. The process according to claim 14 characterised in that the epoxidised rubber composition is cured by sulfur, a sulfur compound or a peroxide.

16. The process according to claim 14 characterised in that the epoxidised rubber is cured by exposure to moisture.

17. The process according to claim 16 characterised in that the epoxidised rubber is cured by exposure to moisture in the presence of a silanol condensation catalyst.

18. The process according to claim 1 wherein Y contains one or more heteroatoms.

19. The process according to claim 1 wherein X is O.

20. A grafted epoxidised rubber having at least one of the formula:
R″—CH(P)—CH₂—C(O)X—Y—SiRₐR′₍₃₋ₐ₎
R″—CH₂—CH(P)—C(O)X—Y—SiRₐR′₍₃₋ₐ₎
R″—C(P)═CH—C(O)X—Y—SiRₐR′₍₃₋ₐ₎
R″—CH═C(P)—C(O)X—Y—SiRₐR′₍₃₋ₐ₎,
wherein R represents a hydrolysable group; R′ represents a hydrocarbyl group having 1 to 6 carbon atoms; a has a value in the range 1 to 3 inclusive; Y represents a divalent organic spacer linkage comprising at least one carbon atom separating the linkage —C(O)X— from the Si atom; X can be S or O; P represents a epoxidised rubber polymer residue; and R″ represents hydrogen or a group of the formula —C(O)X—Y—SiRₐR′₍₃₋ₐ₎ where Y, R and R′ are defined as above.

21. The grafted epoxidised rubber according to claim 20 wherein Y contains one or more heteroatoms and X is O.

22. (canceled)

23. (canceled)

24. (canceled)

25. The process according to claim 11 characterized in that the epoxidised rubber and the unsaturated silane (I) or (II) are reacted at a temperature in the range 120° C. to 180° C.

26. A process of preparing an epoxidised rubber composition containing a reinforcing filler, comprising the step of using a silane coupling agent, wherein the silane coupling agent has the formula:
R″—CH═CH—C(O)X—Y—SiRₐR′₍₃₋ₐ₎ (I) or
R″—C≡C—C(O)X—Y—SiRₐR′₍₃₋ₐ₎ (II)
wherein R represents a hydrolysable group; R′ represents a hydrocarbyl group having 1 to 6 carbon atoms; a has a value in the range 1 to 3 inclusive; Y represents a divalent organic spacer linkage comprising at least one carbon atom separating the linkage —C(O)X— from the Si atom; X can be S or O; and R″ represents hydrogen or a group having an electron withdrawing effect with respect to the —CH═CH— or —C≡C— bond.

27. The process according to claim 26 wherein X is O.

28. A process of making tyres or any parts thereof, engineered rubber goods, belts, or hoses comprising the step of using a curable expoxidised rubber composition produced by the process of claim 1.

29. The grafted epoxidised rubber according to claim 20 wherein Y contains one or more heteroatoms.

30. The grafted epoxidised rubber according to claim 20 wherein X is O.
